(19) United States
(12) Patent Application Publication
(10) Pub. No.: US 2024/0412050 A1
(43) Pub. Date: Dec. 12, 2024

(54) NONLINEAR DRAM DIGITAL EQUALIZATION

(71) Applicant: Micron Technology, Inc., Boise, ID (US)

(72) Inventors: Fa-Long Luo, San Jose, CA (US); Jaime Cummins, Bainbridge Island, WA (US)

(73) Assignee: Micron Technology, Inc., Boise, ID (US)

(21) Appl. No.: 18/734,380

(22) Filed: Jun. 5, 2024

Related U.S. Application Data
(60) Provisional application No. 63/507,165, filed on Jun. 9, 2023.

(51) Int. Cl. G06N 3/048; G06N 3/049

(52) U.S. Cl. CPC G06N 3/048; G06N 3/049

(57) ABSTRACT

The present disclosure relates to signal processing systems that employ various techniques to enhance data transfer quality. In some cases, a memory controller uses a neural network (e.g., time delay neural network (TDNN) to enable nonlinear processing to improve equalization. In some other cases, the memory controller uses an activation function to enable nonlinear processing to improve equalization. The systems may incorporate a finite impulse response (FIR) filter with the activation function applied to its output. A memory controller including a cache may store precomputed values of the activation function. Various types of activation functions or neural network configurations may be employed to introduce nonlinearity and adapt to different application requirements. The present disclosure is applicable in communication systems, control systems, and other digital signal processing systems requiring efficient processing of complex data transmission patterns.

### CROSS REFERENCE TO RELATED APPLICATION(S)

This application claims the benefit under 35 U.S.C. § 119 of the earlier filing date of U.S. Provisional Application Ser. No. 63/507,165 filed Jun. 9, 2023 the entire contents of which are hereby incorporated by reference in their entirety for any purpose.

### BACKGROUND

In some communications systems, data transfer rates have significantly increased due to the growing demand for high-speed data transmission. As a result, there is an increasing need for more efficient encoding and decoding schemes to ensure reliable data transmission. One such scheme is four-level pulse amplitude modulation (PAM4) encoding, which is widely used in high-speed data transmission applications.

PAM4 encoding is a modulation technique that allows for the transmission of four different levels of amplitude for a given signal. By using PAM4 encoding, it is possible to transmit twice the amount of data as compared to traditional binary encoding schemes that only use two amplitude levels. However, imperfect data transfer can occur due to a variety of factors, such as noise, signal distortion, and attenuation.

One of the consequences of imperfect data transfer is that the received signal may not exhibit a perfectly square diagram. The square diagram is a visual representation of the transmitted signal, where each amplitude level is represented by a voltage level. In an ideal scenario, the received signal would have a perfectly square diagram, where each amplitude level is well-defined and separated from the others.

However, in real-world scenarios, the received signal may exhibit a non-square diagram due to various factors that cause signal distortion. This can lead to errors in decoding the signal, as the decoder may have difficulty distinguishing between the different amplitude levels. This can result in lower accuracy and reliability of the transmitted data.

### BRIEF DESCRIPTION OF DRAWINGS

FIG. 1 is a block diagram of a communications system arranged in accordance with examples described herein.

FIG. 2 is a block diagram of another communications system arranged in accordance with examples described herein.

FIG. 3a is a block diagram illustrating a signal processing system for performing equalization on an input signal yₖ using a finite impulse response (FIR) filter and an activation function in accordance with examples described herein.

FIG. 3b is a block diagram illustrating another signal processing system for performing equalization on an input signal yₖ using a FIR filter and an activation function in accordance with examples described herein.

FIG. 3c is a block diagram illustrating a signal processing system for performing equalization on an input signal yₖ using a neural network in accordance with examples described herein.

FIG. 4 is a block diagram of a receiver arranged in accordance with examples described herein.

FIG. 5 is a block diagram of a neural network arranged in accordance with examples described herein.

FIG. 6 is a block diagram of a processing unit arranged in accordance with examples described herein.

FIG. 7 is a flowchart of a method in accordance with examples described herein.

### DETAILED DESCRIPTION

Certain details are set forth below to provide a sufficient understanding of embodiments of the present disclosure. However, it will be clear to one skilled in the art that embodiments of the present disclosure may be practiced without various knowledge of these particular details. In some instances, well-known wireless communication components, circuits, control signals, timing protocols, computing system components, and software operations have not been shown in detail in order to avoid unnecessarily obscuring the described embodiments of the present disclosure.

A memory controller and a memory device may communicate with one another, and may encode and decode data before and/or after transmission. Some encoding techniques (e.g., PAM4 encoding) may be used for high speed data transfer. However, imperfect data transfer for high speed data transfer scenarios may lead to less than square eye diagrams. An eye diagram may be a graphical representation of a digital signal that may illustrate a signal's waveform over time. A less than square eye diagram may indicate that the signal is not cleanly transitioning between amplitude levels (e.g., between four amplitude levels in the case of PAM4), which may lead to errors in data transmission. Such distortion or loss of amplitude levels may be caused by one or more of factors, such as noise or signal reflections.

To improve the quality of data transfer and to ensure more accurate decoding of the PAM4 signal, advanced signal processing techniques can be used, such as equalization or error correction coding. These techniques can help to mitigate the effects of imperfect data transfer and improve the overall quality of the signal.

The present disclosure describes utilizing activation functions or neural networks to improve quality of data transfer. Activation functions or one or more neural networks may be used to improve the shape of the eye diagram in a communication system via equalization. Equalization may be a technique used to adjust the frequency response of a channel to compensate for distortion, such as ISI, and improve the accuracy of data transmission.

In some examples, an activation function may be added to a finite impulse response (FIR) filter to enable nonlinear filtering to improve the quality of data transfer with PAM4 signals.

In some other examples, a neural network may be used as an equalizer in a communication system. The neural network may be trained to learn the mapping between a distorted input signal and a desired output signal, which may be the transmitted data. Using a neural network as an equalizer may have several advantages over traditional equalization techniques (e.g., a FIR filter). For example, a neural network may be able to adapt to changes in channel characteristics and handle nonlinear distortion. The neural network may be able to replace the entire FIR filter in some cases.

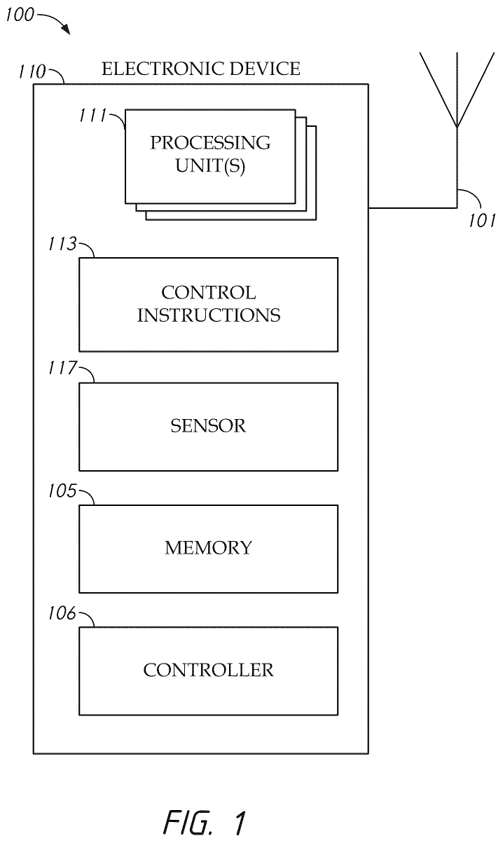

FIG. 1 is a block diagram of a wireless communications system arranged in accordance with examples described herein. Computing system 100 includes electronic device 110. The electronic device 110, coupled to the antenna 101, includes a sensor 117. The electronic device 110, which may be implemented on a reconfigurable fabric, includes processing units 111 and control instructions 113. The control instructions 113 may be stored on non-transitory computer readable media, for example, as encoded executable instructions, which, when executed by a processor (e.g., a reconfigurable fabric), is configured to cause the electronic device 110 to perform certain operations described herein. In some examples, the electronic device 110 may communicate with another device using physical connections. In other examples, the electronic device 110 include antennas 101 to transmit or receive wireless communication signals, for example, modulated RF signals on a specific wireless band. The electronic device 110 may include a memory 105 to store information and a controller 106 configured to communicate with the memory 105.

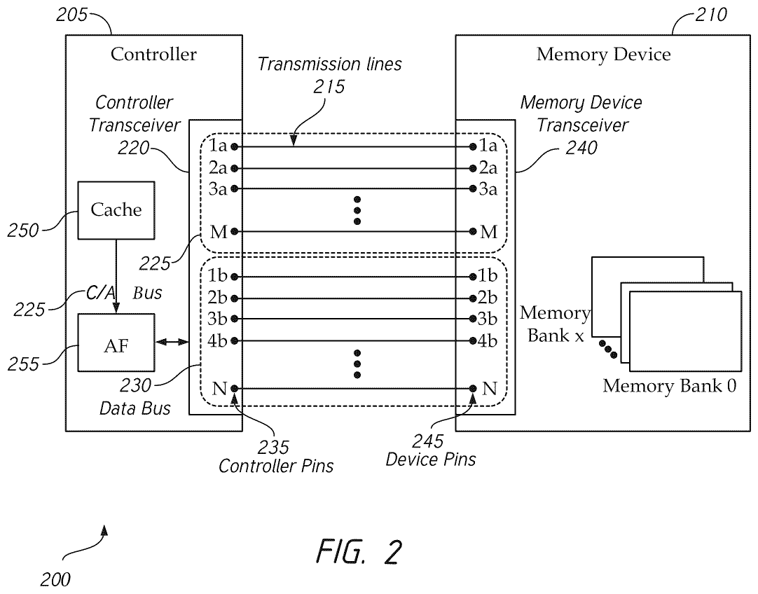

Control instructions 113 may configure the respective electronic devices 110 for specific configurations. Control instructions 113 may be locally implemented on each electronic device 110. The electronic devices 110 may utilize the respective control instructions 113 to control wired or wireless communication; and, to control the respective sensors 117. In other examples, fewer, additional, and/or different components may be provided. For example, while described above with each electronic device including a single sensor, in other examples, multiple sensors may be included in each electronic device 110. Or, electronic device 110 may include a memory device such as memory device 210 of FIG. 2, and additional memory controller such as memory controller 205 of FIG. 2.

Electronic devices described herein, such as electronic device 110 shown in FIG. 1 may be implemented using generally any electronic device for which wired or wireless communication capability is desired. For example, electronic device 110 may be implemented using a mobile phone, smartwatch (or other wearable device), computer (e.g., server, laptop, tablet, desktop), or radio. In some examples, the electronic device 110 may be incorporated into and/or in communication with other apparatuses for which communication capability is desired, including devices associated with the Internet of Things (IoT), such as but not limited to, an automobile, airplane, helicopter, appliance, tag, camera, or other device. While not explicitly shown in FIG. 1, electronic device 110 may include any of a variety of components in some examples, including, but not limited to, memory, input/output devices, circuitry, processing units (e.g., processing elements and/or processors), or combinations thereof.

To support wired communication, the electronic device may include any number of input and/or/output pins or contacts (not shown). To support wireless communication, the electronic device 110 may include multiple antennas. For example, the electronic device 110 may each have more than two antennas. While electronic device 110 includes one antenna, generally any number of antennas may be used including 2, 3, 4, 5, 6, 7, 8, 9, 10, 11, 12, 13, 14, 15, 16, 32, 64, or 96 antennas. Other numbers of antennas may be used in other examples.

Each of the processing unit(s) 111 may be implemented using one or more operand processing units, such as an arithmetic logic unit (ALU), a bit manipulation unit, a multiplication unit, an accumulation unit, an adder unit, a look-up table unit, a memory look-up unit, or any combination thereof. In some examples, each of the processing unit(s) 111 may include circuitry, including custom circuitry, and/or firmware for performing functions described herein. For example, circuitry can include multiplication unit/accumulation units for performing the described functions, as described herein. Each of the processing unit(s) 111 can be implemented as a microprocessor or a digital signal processor (DSP), or any combination thereof. For example, processing unit(s) 111 can include levels of caching, such as a level one cache and a level two cache, a core, and registers. In some examples, one or more processing units 111 may communicate with memory 105 (e.g., via memory controller 106). Communication between memory 105 and controller 106 may be described further in FIG. 2.

Sensor 117 may be any type of sensor for monitoring and/or detecting changes in environmental conditions of the respective electronic device 110, which may be referred to as environmental characteristics of each respective electronic device 110. For example, sensor 117 may monitor environmental conditions of its surroundings utilizing mechanisms of the sensor to detect or monitor changes to that environment. Various detecting mechanisms may be utilized by the sensor 117 including, but not limited to mechanisms that are electrical, chemical, mechanical, or any combination thereof. For example, the sensor 117 may detect changes in a road or building structure utilizing a mechanical actuator that translates energy into an electrical signal. As another example, sensor 117 may detect changes in a sugar level of the blood utilizing a chemical sensor that translates energy into an electrical signal. Various types of sensors, for example any type of sensor that may be utilized in an electronic device and coupled to a processing unit 111.

In some examples, the memory 105 and/or the controller 106 may employ activation functions or neural networks to improve quality of data transfer therebetween (or in communication with other devices). Activation functions or one or more neural networks may be used to improve the shape of the eye diagram in a communication system via equalization, which may improve communication reliability by the memory 105 and/or the controller 106. In some examples, an activation function may be added to a finite impulse response (FIR) filter to enable nonlinear filtering to improve the quality of data transfer with PAM4 signals. In other examples, a neural network may be used as the equalizer in the memory 105 and/or the controller 106. The neural network may be trained to learn the mapping between a distorted input signal and a desired output signal, which may be the transmitted data. Using a neural network as an equalizer may have several advantages over traditional equalization techniques (e.g., a FIR filter). For example, a neural network may be able to adapt to changes in channel characteristics and handle nonlinear distortion. The neural network may be able to replace the entire FIR filter in some cases.

FIG. 2 illustrates a communications system 200 using encoding (e.g., PAM4 encoding) in accordance with examples described herein. The system 200 includes a controller 205 in communication with a memory device 210 via transmission lines (e.g., conductive wires or traces) 215. The controller 205 includes a controller transceiver 220 that communicates over the transmission lines 215 using controller pins 235. The memory device 210 includes a memory device transceiver 240 that transmits or receives via the transmission lines 215 via device pins 245. The memory device 210 includes a plurality of memory banks. The electronic device 110 of FIG. 1 may implement the controller 205 and/or the memory device 210, in some examples.

The controller 205 includes a cache 250, which is coupled to an activation function (AF) circuit 255, which is coupled to the controller transceiver 220. The AF circuit 255 implements an activation function to improve data transfer that uses encoding such as PAM4 encoding. The cache 250 may be a temporary storage mechanism that retains frequently accessed or recently used data for quick retrieval. The memory controller 205 may reduce processing time required for nonlinear operations, improving overall system performance by storing precomputed activation function values in cache 250.

When the activation function of AF circuit 255 is applied, the memory controller 205 may check if the corresponding output value for a given input is already present in the cache. If it is, the controller 205 may retrieve the cached value and use it as the output of the AF circuit 255. If the value is not present in the cache, AF circuit 255 may compute the activation function output for the given input, store the result in the cache 250, and use the computed value as the output.

The transmission lines 215 include a command/address bus 225 and a data bus 230. The command/address bus 225 is used to transmit control signals and memory addresses between the controller 205 and the memory device 210. The data bus 230 is used to transmit data between the controller 205 and the memory device 210.

The controller transceiver 220 communicates with the memory device transceiver 240 over the transmission lines 215 using the controller pins 235 and the device pins 245. The controller transceiver 220 may convert the data to be transmitted into a suitable format for transmission over the transmission lines 215, such as using PAM4 encoding. The memory device transceiver 240 may receive the transmitted data and converts it back to its original format. Additionally or alternatively, the memory device transceiver 240 converts data to be transmitted into a suitable format for transmission over the transmission lines 215, such as using PAM4 encoding. Memory device 210 may include corresponding AF 255 and cache 250 in some examples.

In some examples, the AF circuit 255 may employ one or more neural networks to improve quality of data transfer therebetween (or in communication with other devices). The one or more neural networks may be used to improve the shape of the eye diagram in a communication system via equalization, which may improve communication reliability by the controller transceiver 220 (or the memory device transceiver 240). In some examples, a neural network may be used as the equalizer in the memory 105 and/or the controller 106. The neural network may be trained to learn the mapping between a distorted input signal and a desired output signal, which may be the transmitted data. Using a neural network as an equalizer may have several advantages over traditional equalization techniques (e.g., a FIR filter). For example, a neural network may be able to adapt to changes in channel characteristics and handle nonlinear distortion. The neural network may be able to replace the entire FIR filter in some cases

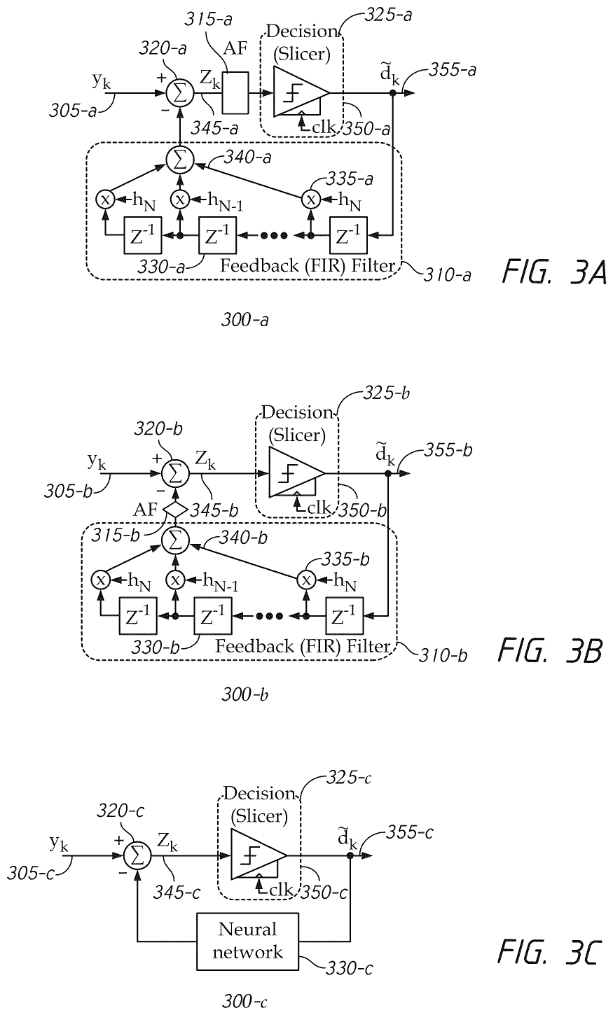

FIG. 3a is a block diagram illustrating a signal processing system 300-a for performing equalization on an input signal yₖ 305-a using a FIR filter 310-a and an activation function 315-a according to embodiments of the disclosure. The electronic device 110 of FIG. 1 and/or the controller 205 and/or the memory device 210 of FIG. 2 may implement the signal processing system 300-a in some examples. The signal processing system 300-a includes several components, including a first summation circuit 320-a, an activation function 315-a, a decision slicer 325-a, an FIR filter 310-a with unit delays 330-a and taps 335-a, and a second summation circuit 340-a.

The input signal yₖ 305-a is provided to the first summation circuit 320-a. The first summation circuit 320-a receives two inputs: the input signal yₖ 305-a and the output from the FIR filter. The first summation circuit 320-a subtracts the output from the FIR filter from the input signal yₖ 305-a to generate an intermediate signal zₖ 345-a.

The intermediate signal zₖ 345-a, produced by the first summation circuit 320-a, is then provided to the activation function 315-a. The activation function 315-a introduces nonlinear processing capabilities to the system by applying a nonlinear transformation to the intermediate signal zₖ 345-a. This transformation allows the system to effectively address and mitigate nonlinear distortions or artifacts in the input signal that a linear FIR filter alone may not be able to handle.

The output of the activation function 315-a is then provided to the decision slicer 325-a, which operates under an input clock signal (clk) 350-a. The decision slicer 325-a, also known as a slicer or quantizer, is responsible for making decisions on the received signal, converting the continuous or discrete-time signal from the activation function 315-a into a discrete-time, discrete-amplitude signal. The output of the decision slicer is denoted as dₖ 355-a.

The output dₖ 355-a from the decision slicer is fed into the FIR filter 310-a, which may be implemented in a direct form discrete-time configuration in some cases. The FIR filter 310-a includes a series of unit delays 330-a, taps 335-a with coefficients h, and a second summation circuit 340-a. The unit delays 330-a are used to store and shift the input samples, allowing the FIR filter 310-a to operate on a sequence of input samples over time. The taps 335-a represent the FIR filter coefficients (h) that are multiplied with the corresponding delayed input samples. These weighted samples are then combined using the second summation circuit 340-a to produce the output of the FIR filter 310-a.

The output of the FIR filter 310-a is then fed back to the first summation circuit 320-a, where it is subtracted from the input signal yₖ 305-a. This feedback process allows the system to adaptively equalize the input signal by canceling out or reducing undesired components or distortions.

FIG. 3b is a block diagram illustrating a signal processing system 300-b for performing equalization on an input signal yₖ 305-b using a FIR filter 310-b and an activation function 315-b in accordance with examples described herein. The electronic device 110 of FIG. 1 and/or the controller 205 and/or the memory device 210 of FIG. 2 may implement the signal processing system 300-b in some examples. In this configuration, the activation function 315-b is placed after the output of the FIR filter 310-b and before the first summation circuit 320-b. The signal processing system 300-b includes several components, including the first summation circuit 320-b, the activation function 315-b, a decision slicer 325-b, an FIR filter 310-b with unit delays 330-b, taps 335-b, and a second summation circuit 340-b.

The input signal yₖ 305-b is provided to the first summation circuit 320-b, which provides a signal zₖ to the decision slicer 325-b, which operates under the input clock signal (clk) 350-b. The decision slicer 325-b, also known as a slicer or quantizer, is responsible for making decisions on the received signal, converting the continuous or discrete-time signal into a discrete-time, discrete-amplitude signal. The output of the decision slicer is denoted as dₖ 355-b.

The output dₖ 355-b from the decision slicer is fed into the FIR filter 310-b, which may be implemented in a direct form discrete-time configuration in some cases. The FIR filter 310-b includes a series of unit delays 330-b, taps 335-b with coefficients h, and a second summation circuit 340-b. The unit delays 330-b are used to store and shift the input samples, allowing the FIR filter 310-b to operate on a sequence of input samples over time. The taps 335-b represent the FIR filter coefficients (h) that are multiplied with the corresponding delayed input samples. These weighted samples are then combined using the second summation circuit to produce the output of the FIR filter 310-b.

The output of the FIR filter 310-b is then provided to the activation function 315-b. The activation function 315-b introduces nonlinear processing capabilities to the system by applying a nonlinear transformation to the output of the FIR filter 310-b. This transformation allows the system to effectively address and mitigate nonlinear distortions or artifacts in the input signal that a linear FIR filter 310-b alone might not be able to handle.

The output of the activation function 315-b is then fed back to the first summation circuit 320-b, where it is subtracted from the input signal yₖ 305-b to generate the intermediate signal zₖ 345-b. This feedback process allows the system to adaptively equalize the input signal by canceling out or reducing undesired components or distortions.

One difference in this configuration is the placement of the activation function 315-b after the FIR filter output and before the first summation circuit 320-b, which allows for nonlinear processing to be applied directly to the filter output before it is combined with the input signal yₖ 305-b.

FIG. 3c is a block diagram illustrating a signal processing system 300-c for performing equalization on an input signal yₖ 305-c using a neural network in accordance with examples described herein. The electronic device 110 of FIG. 1 and/or the controller 205 and/or the memory device 210 of FIG. 2 may implement the signal processing system 300-c in some examples. The signal processing system 300-c includes several components, including a summation circuit 320-c, a decision slicer 325-c, and a neural network 330-c, which may be a time delay neural network (TDNN) in some cases.

The input signal yₖ 305-c is provided to the summation circuit 320-c, where it is combined with the output of the neural network 330-c to produce an intermediate signal zₖ 345-c.

The intermediate signal zₖ 345-c is then provided to the decision slicer 325-c, which operates under the input clock signal (clk) 350-c. The decision slicer 325-c, also known as a slicer or quantizer, is responsible for making decisions on the received signal, converting the continuous or discrete-time signal into a discrete-time, discrete-amplitude signal. The output of the decision slicer is denoted as dₖ 355-c.

The output dₖ 355-c from the decision slicer is fed into the neural network 330-c. In some cases, the neural network 330-c may be implemented as a time delay neural network (TDNN), which is capable of modeling data in series by incorporating delays into the input data via delay neurons.

The neural network processes the input data dₖ 355-c and provides an output signal that represents the equalization adjustments to be applied to the input signal yₖ 305-c. This output signal is then fed back to the summation circuit 320-c, where it is subtracted from the input signal yₖ 305-c to generate the equalized intermediate signal zₖ 345-c. The summation circuit 320-c adds or subtracts signals, effectively combining the input signal yₖ 305-c with the output from the neural network 330-c to generate the intermediate signal zₖ 345-c, the equalized version of the input signal.

The signal processing system 300-c depicted in the figure performs equalization on the input signal yₖ 305-c using a neural network 330-c, which may be a time delay neural network in some cases. The components, including the summation circuit 320-c, the decision slicer 325-c, and the neural network 330-c, work to process and equalize the input signal, mitigating distortions and artifacts that may be present due to the characteristics of the signal. The neural network 330-c enables adaptive equalization by learning the appropriate adjustments to be applied to the input signal based on the output from the decision slicer, and allowing for nonlinear filtering that may otherwise not be possible by using only a linear FIR filter.

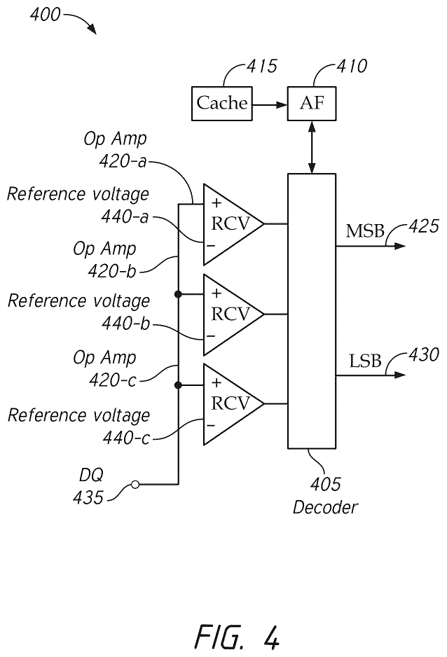

FIG. 4 is a block diagram illustrating a receiver 400 (e.g., a PAM4 receiver). The PAM4 receiver is designed to decode and process PAM4 encoded data and includes several key components, including a PAM4 decoder 405, an activation function 410, a cache 415, and three receive (RCV) operational amplifiers (op amps) 420. The electronic device 110 of FIG. 1, the controller 205 and/or the memory device 210 of FIG. 2, and/or any of the signal processing systems 300-a to c of FIGS. 3A-3C, respectively, may implement the receiver 400 in some examples.

The PAM4 decoder 405 is responsible for converting the PAM4 encoded data received from the RCV op amps 420 into two separate binary signals, namely the most significant bit (MSB) 425 and the least significant bit (LSB) 430. These two output signals represent the decoded data and can be further processed or utilized by other components in the system.

The activation function 410 is in communication with the PAM4 decoder 405 and introduces nonlinear processing capabilities to the system. It applies a nonlinear transformation to the input data from the PAM4 decoder 405, allowing the receiver to effectively address and mitigate nonlinear distortions or artifacts in the received PAM4 encoded data that linear processing alone might not be able to handle.

A cache 415 is used to provide data to the activation function 410. The cache 415 stores precomputed values or other relevant information that the activation function 410 may require for efficient processing. This stored data can help reduce the computational complexity and latency of the activation function 410, ultimately improving the overall performance of the PAM4 receiver 400.

The three RCV op amps 420 are used to amplify and process the incoming PAM4 encoded data (DQ) 435 before providing it to the PAM4 decoder 405. Each op amp 420 has a positive terminal connected to the data line (DQ) 435 and a negative terminal connected to one of the reference voltages 440: VREFDU, VREFDM, and VREFDL. These reference voltages help set the appropriate thresholds for each op amp 420 to correctly process the PAM4 encoded data.

VREFDU, VREFDM, and VREFDL are the reference voltages used to establish the decision levels for the three RCV op amps. VREFDU is connected to the negative terminal of the first op amp 420-a, VREFDM to the negative terminal of the second op amp 420-b, and VREFDL to the negative terminal of the third op amp 420-c. These reference voltages are crucial for accurate signal detection and decoding of the PAM4 encoded data.

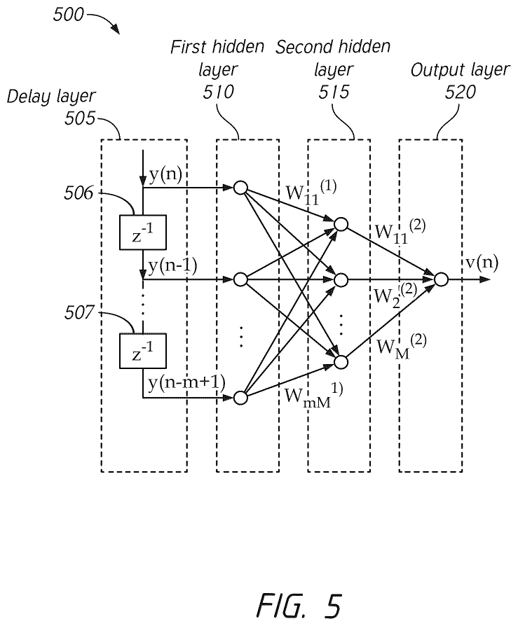

FIG. 5 is a block diagram of a neural network 500 in accordance with examples described herein. Neural network 500 may be implemented as a nonlinear filter, such as in neural network 330-c in FIG. 3c. In some examples, neural network 500 may be a delay neural network (e.g., a time delay neural network (TDNN)).

Neural network 500 may model data in series by incorporating delays into the input data via delay neurons of delay layer 505. Each delay neuron (e.g., z−1) of delay layer 505 may receive inputs from a previous neuron with a delay. For example, delay neuron 506 delays the input signal y(n) and outputs the previous input data y(n−1) (e.g., denoted by n−1). Delay neuron 506 may provide the delayed input signal y(n−1) to a subsequent delay neuron (e.g., delay neuron 507) and to one or more input neurons of the first hidden layer 510.

The first hidden layer 510 of neural network 500 may include one or more neurons that receive the data. Weights may be applied to the series data, and provided to a second hidden layer 515. Additional weights may be applied to the data, and provided to the output layer 520.

During a training phase for neural network 500, the weights of the network may be adjusted using one or more optimization algorithms (e.g., gradient descent) to reduce an error between a predicted output and the actual output. The network may be trained using supervised learning, unsupervised learning, or both. Once trained, neural network 500 may be used to predict future values of the data series based on past values.

The TDNN architecture of neural network 500 allows for the efficient processing of time-series data by incorporating temporal dependencies into its structure. This enables the neural network to capture patterns and relationships within the data that span across different time steps, thereby enhancing its predictive capabilities and overall performance.

The first hidden layer 510, second hidden layer 515, or both, may comprise one or more layers of neurons that perform nonlinear transformations on the weighted input data. These transformations enable the neural network to learn complex, nonlinear relationships within the time-series data. The hidden layer may employ various activation functions, such as sigmoid, hyperbolic tangent (tanh), Rectified Linear Unit (ReLU), or Leaky ReLU, to introduce nonlinearity to the neural network.

The output layer 520 generates the final output of the neural network, which may represent the predicted value of the data series or a processed version of the input signal. The output layer may consist of one or more output neurons, each employing an activation function to produce the final output values.

Neural network 500 may be utilized in various applications where nonlinear filtering is required, such as signal processing, communication systems, and control systems. By replacing the traditional FIR filter with the TDNN architecture, the system can benefit from the enhanced processing capabilities offered by the neural network, leading to improved performance and adaptability to complex data patterns.

The neural network 500 may be implemented using various hardware and software components, including dedicated processing units, field-programmable gate arrays (FPGAs), application-specific integrated circuits (ASICs), or general-purpose processors running software implementations. The choice of implementation may depend on the specific requirements of the application, such as processing speed, power consumption, and adaptability to changing data patterns.

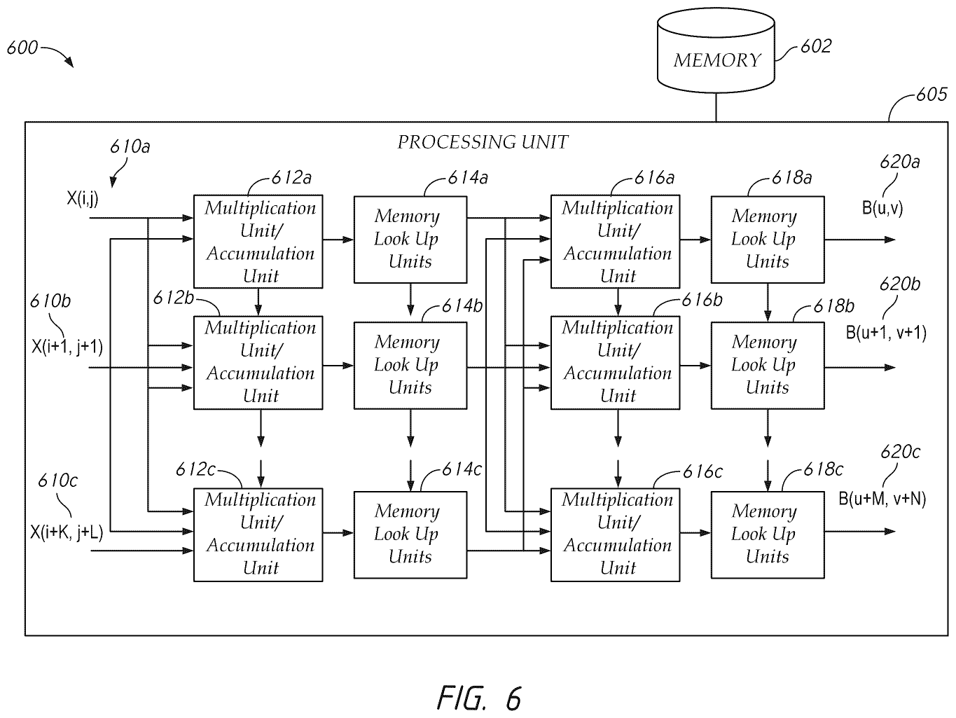

FIG. 6 is a block diagram of a processing unit 605 arranged in a computing system 600 in accordance with examples described herein. The system 600 may be included in the electronic device 110 of FIG. 1 and/or the controller 205 and/or the memory device 210 of FIG. 2, for example. For example, a processing unit 111 may include processing unit 605, and memory 105 may include memory 602. The processing unit 605 may receive input data (e.g. X (i,j)) 610a-c from such a computing system. In some examples, the input data 610a-c may be input data, such as data received from a sensor or data stored in the memory 602. For example, data stored in the memory 602 may be output data generated by one or more processing units implementing another processing stage. The processing unit 605 may include multiplication unit/accumulation units 612a-c, 616a-c and memory lookup units 614a-c, 618a-c that, when mixed with weight data retrieved from the memory 602, may generate output data (e.g. B (u,v)) 620a-c. In some examples, the output data 620a-c may be utilized as input data for another processing stage or as output data to be transmitted via an antenna. In some examples, the processing unit 605 may communicate with memory 602 (e.g., memory 210) via a controller (e.g., controller 205).

In implementing one or more processing units 605, a computer-readable medium at an electronic device may execute respective control instructions to perform operations through executable instructions within a processing unit 605. For example, the control instructions provide instructions to the processing unit 605, that when executed by the computing device, cause the processing unit 605 to configure the multiplication units 612a-c to multiply input data 610a-c with weight data and accumulation units 616a-c to accumulate processing results to generate the output data 620a-c.

The multiplication unit/accumulation units 612a-c, 616a-c multiply two operands from the input data 610a-c to generate a multiplication processing result that is accumulated by the accumulation unit portion of the multiplication unit/accumulation units 612a-c, 616a-c. The multiplication unit/accumulation units 612a-c, 616a-c adds the multiplication processing result to update the processing result stored in the accumulation unit portion, thereby accumulating the multiplication processing result. For example, the multiplication unit/accumulation units 612a-c, 616a-c may perform a multiply-accumulate operation such that two operands, M and N, are multiplied and then added with P to generate a new version of P that is stored in its respective multiplication unit/accumulation units. The memory look-up units 614a-c, 618a-c retrieve weight data stored in memory 602. For example, the memory look-up unit can be a table look-up that retrieves a specific weight. The output of the memory look-up units 614a-c, 618a-c is provided to the multiplication unit/accumulation units 612a-c, 616a c that may be utilized as a multiplication operand in the multiplication unit portion of the multiplication unit/accumulation units 612a-c, 616a-c. Using such a circuitry arrangement, the output data (e.g. B (u,v)) 620a-c may be generated from the input data (e.g. X (i,j)) 610a-c.

In some examples, weight data, for example from memory 602, can be mixed with the input data X (i,j) 610a-c to generate the output data B (u,v) 620a-c. The relationship of the weight data to the output data B (u,v) 620a-c based on the input data X (i,j) 610a-c may be expressed as:

$$B ( u , v ) = f ( {\sum }_{m , n}^{M , N} {a}_{m , n}^{″} f ( {\sum }_{k , l}^{K , L} {a}_{k , l}^{′} X ( i + k , j + l ) ) ) \qquad Equation ( 1 )$$

where a′_{k,l}, a″_{m,n} are weights for the first set of multiplication/accumulation units 612a-c and second set of multiplication/accumulation units 616a-c, respectively, and where f(·) stands for the mapping relationship performed by the memory look-up units 614a-c, 618a-c. As described above, the memory look-up units 614a-c, 618a-c retrieve weights to mix with the input data. Accordingly, the output data may be provided by manipulating the input data with multiplication/accumulation units using a set of weights stored in the memory associated with a desired transmission protocol. The resulting mapped data may be manipulated by additional multiplication/accumulation units using additional sets of weights stored in the memory associated with the desired transmission protocol. The sets of weights multiplied at each stage of the processing unit 605 may represent or provide an estimation of the processing of the input data in specifically-designed hardware (e.g., an FPGA).

Further, it can be shown that the system 600, as represented by Equation (1), may approximate any nonlinear mapping with arbitrarily small error in some examples and the mapping of system 600 is determined by the weights a′_{k,l}, a″_{m,n}. For example, if such weight data is specified, any mapping and processing between the input data X (i,j) 610a-c and the output data B (u,v) 620a-c may be accomplished by the system 600. Such a relationship, as derived from the circuitry arrangement depicted in system 600, may be used to train an entity of the computing system 600 to generate weight data. For example, using Equation (1), an entity of the computing system 600 may compare input data with the output data to generate the weight data.

In the example of system 600, the processing unit 605 mixes the weight data with the input data X (i,j) 610a-c utilizing the memory look-up units 614a-c, 618a-c. In some examples, the memory look-up units 614a-c, 618a-c can be referred to as table look-up units. The weight data may be associated with a mapping relationship for the input data X (i,j) 610a-c to the output data B (u,v) 620a-c. For example, the weight data may represent non-linear mappings of the input data X (i,j) 610a-c to the output data B (u,v) 620a-c. In some examples, the non-linear mappings of the weight data may represent a Gaussian function, a piece-wise linear function, a sigmoid function, a thin-plate-spline function, a multi-quadratic function, a cubic approximation, an inverse multi-quadratic function, or combinations thereof. In some examples, some or all of the memory look-up units 614a-c, 618a-c may be deactivated. For example, one or more of the memory look-up units 614a-c, 618a-c may operate as a gain unit with the unity gain.

Each of the multiplication unit/accumulation units 612a-c, 616a-c may include multiple multipliers, multiple accumulation units, or and/or multiple adders. Any one of the multiplication unit/accumulation units 612a-c, 616a may be implemented using an ALU. In some examples, any one of the multiplication unit/accumulation units 612a-c, 616a-c can include one multiplier and one adder that each perform, respectively, multiple multiplications and multiple additions. The input-output relationship of a multiplication/accumulation unit 612, 616 may be represented as:

$${B}_{out} = {\sum }_{i = 1}^{I} {C}_{i} * {B}_{in} ( i ) \qquad Equation ( 2 )$$

where “I” represents a number to perform the multiplications in that unit, Cᵢ the weights which may be accessed from a memory, such as memory 602, and Bᵢₙ(i) represents a factor from either the input data X (i,j) 610a-c or an output from multiplication unit/accumulation units 612a-c, 616a-c. In an example, the output of a set of multiplication unit/accumulation units, Bₒᵤₜ, equals the sum of weight data, Cᵢ multiplied by the output of another set of multiplication unit/accumulation units, Bᵢₙ(i). Bᵢₙ(i) may also be the input data such that the output of a set of multiplication unit/accumulation units, Bₒᵤₜ, equals the sum of weight data, Cᵢ multiplied by input data.

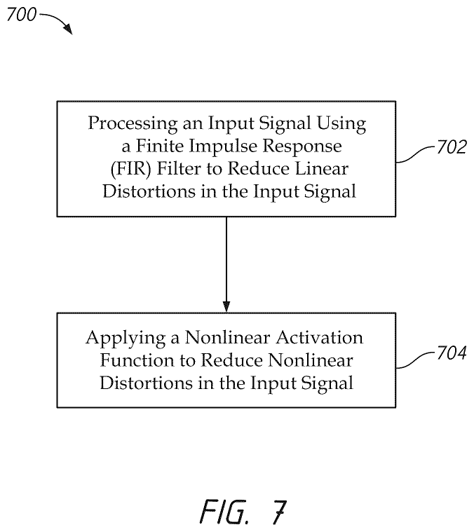

FIG. 7 is a flowchart of a method 700 in accordance with examples described herein. Example method 700 may be implemented using, for example, communications system 100 in FIG. 1, communication system 200 in FIG. 2, or any system or combination of the systems depicted in FIG. 1 or 2 described herein. The operations described in blocks 702 704 may also be stored as control instructions in a computer-readable medium at memory controller 205 or memory device 210. In some examples, the method 700 may be implemented in a non-transitory computer readable medium including instructions executable to cause a wireless communication device to perform one or more of the operations of the method 700.

The method 700 may include processing an input signal using a FIR filter to reduce linear distortions in the input signal, at 702. In some examples, the method 700 may include configuring the FIR filter with adjustable filter coefficients.

The method 700 may include applying a nonlinear activation function to reduce nonlinear distortions in the input signal, and 704. In some examples, the method 700 may include storing precomputed values of the nonlinear activation function in a cache. In some examples, the method 700 may include initializing the cache during system startup. In some examples, the method 700 may include checking the cache for precomputed activation function values during processing. In some examples, the method 700 may include applying the nonlinear activation function before a summation circuit junction. In some examples, the method 700 may include applying the nonlinear activation function after a summation circuit junction. In some examples, the wherein the nonlinear activation function is selected from a group consisting of sigmoid, tanh, ReLU, and Leaky ReLU.

The steps 702 and 704 of the method 700 are for illustration purposes. In some examples, the steps 702 and 704 may be performed in a different order. In some other examples, various steps 702 and 704 may be eliminated. In still other examples, various steps 702 and 704 may be divided into additional steps, supplemented with other steps, or combined together into fewer steps. Other variations of these specific steps are contemplated, including changes in the order of the steps, changes in the content of the steps being split or combined into other steps, etc.

Certain details are set forth above to provide a sufficient understanding of described examples. However, it will be clear to one skilled in the art that examples may be practiced without various of these particular details. The description herein, in connection with the appended drawings, describes example configurations and does not represent all the examples that may be implemented or that are within the scope of the claims. The terms “exemplary” and “example” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Techniques described herein may be used for various wireless communications systems, which may include multiple access cellular communication systems, and which may employ code division multiple access (CDMA), time division multiple access (TDMA), frequency division multiple access (FDMA), orthogonal frequency division multiple access (OFDMA), or single carrier frequency division multiple access (SC-FDMA), or any a combination of such techniques. Some of these techniques have been adopted in or related to standardized wireless communication protocols by organizations such as Third Generation Partnership Project (3GPP), Third Generation Partnership Project 2 (3GPP2) and IEEE. These wireless standards include Ultra Mobile Broadband (UMB), Universal Mobile Telecommunications System (UMTS), Long Term Evolution (LTE), LTE-Advanced (LTE-A), LTE-A Pro, New Radio (NR), IEEE 802.11 (WiFi), and IEEE 802.16 (WiMAX), among others.

The various illustrative blocks and modules described in connection with the disclosure herein may be implemented or performed with a general-purpose processor, a digital signal processor (DSP), an application-specific integrated circuit (ASIC), a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), or optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above are also included within the scope of computer-readable media.

Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

From the foregoing it will be appreciated that, although specific examples have been described herein for purposes of illustration, various modifications may be made while remaining with the scope of the claimed technology. The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. An apparatus for signal processing, comprising:
a finite impulse response (FIR) filter configured to process a first input signal to reduce linear distortions in the input signal; and
a neural network node configured to implement an activation function to apply a nonlinear activation function to reduce nonlinear distortions in the input signal.

2. The apparatus of claim 1, wherein the nonlinear activation function is selected from a group consisting of sigmoid, hyperbolic tangent (tanh), Rectified Linear Unit (ReLU), Leaky ReLU, or a combination thereof.

3. The apparatus of claim 1, further comprising:
a cache configured to store precomputed values of the nonlinear activation function.

4. The apparatus of claim 3, wherein the cache is configured to check for precomputed activation function values during processing.

5. The apparatus of claim 1, further comprising:
a summation circuit junction configured to subtract an output of the FIR filter from a second input signal, and to provide an output of the summation circuit junction to the neural network node configured to implement the activation function.

6. The apparatus of claim 1, further comprising:
a summation circuit junction configured to subtract an output of the FIR filter from a second input signal, wherein the neural network node configured to implement the activation function is between the output of the FIR filter and the summation circuit junction.

7. An apparatus for signal processing, comprising:
a neural network configured to process a first input signal for signal equalization and provide an output signal, the output signal representative of signal noise or distortions; and
a summation circuit junction configured to subtract the output from a second input signal.

8. The apparatus of claim 7, wherein the neural network comprises one or more delay neurons, and wherein the neural network is a time delay neural network (TDNN).

9. The apparatus of claim 8, wherein the neural network includes one or more hidden layers and an output layer.

10. The apparatus of claim 8, wherein the neural network is configured to process time-series data.

11. The apparatus of claim 8, wherein the neural network is trained using supervised learning, unsupervised learning, or both.

12. The apparatus of claim 8, further comprising:
a slicer configured to convert a continuous or discrete-time signal from the summation circuit junction into a discrete-time, discrete-amplitude signal for the neural network.

13. A method for signal processing, comprising:
processing an input signal using a finite impulse response (FIR) filter to reduce linear distortions in the input signal; and
applying a nonlinear activation function to reduce nonlinear distortions in the input signal.

14. The method of claim 13, further comprising:
storing precomputed values of the nonlinear activation function in a cache.

15. The method of claim 14, further comprising:
initializing the cache during system startup.

16. The method of claim 14, further comprising:
checking the cache for precomputed activation function values during processing.

17. The method of claim 13, further comprising:
applying the nonlinear activation function before a summation circuit junction.

18. The method of claim 13, further comprising:
applying the nonlinear activation function after a summation circuit junction.

19. The method of claim 13, wherein the nonlinear activation function is selected from a group consisting of sigmoid, hyperbolic tangent (tanh), Rectified Linear Unit (ReLU), and Leaky ReLU.

20. The method of claim 13, further comprising:
configuring the FIR filter with adjustable filter coefficients.
